(19) United States
(12) Patent Application Publication
(10) Pub. No.: US 2025/0119726 A1
(43) Pub. Date: Apr. 10, 2025

(54) DATA RETRIEVAL AND SUBSCRIPTION OPTIMIZATION

(71) Applicant: Telefonaktiebolaget LM Ericsson (publ), Stockholm (SE)

(72) Inventors: Ping ZHOU, SHANGHAI (CN); Cheng WANG, SHANGHAI (CN); Jianxin MA, SHANGHAI (CN); Yunjie LU, SHANGHAI (CN); Chunbo WANG, SHANGHAI (CN)

(73) Assignee: Telefonaktiebolaget LM Ericsson (publ), Stockholm (SE)

(21) Appl. No.: 18/836,245

(22) PCT Filed: Feb. 6, 2023
(86) PCT No.: PCT/EP2023/052769

§ 371 Date: Aug. 6, 2024

(30) Foreign Application Priority Data
Feb. 7, 2022 (WO) PCT/CN2022/075342

(51) Int. Cl. H04W 8/18

(52) U.S. Cl. CPC H04W 8/18

(57) ABSTRACT

According to an aspect, there is provided a method performed by a network function consumer, NFC. The method comprises sending (701) a request (401) to a network function producer, NFP, wherein the request (401) is for context information for a first wireless device, and wherein the request (401) comprises one or more filter values identifying a subset of context information for the first wireless device required by the NFC. The subset of context information for the first wireless device required by the NF consumer is related to specific Protocol Data Unit, PDU, sessions.

### TECHNICAL FIELD

This disclosure relates to network function (NF) consumers (NFCs) and NF producers (NFPs), and in particular to requests and retrieval of data from a NFP by an NFC.

### BACKGROUND

This disclosure relates to Network Function (NF) nodes referred to as NF consumers (NFCs) that are to consume services provided by other NF nodes referred to as NF Producers (NFPs).

The 3^{rd} Generation Partnership Project (3GPP) defines procedure to support Protocol Data Unit (PDU) session continuity during intersystem mobility procedures back and forth between the 5th Generation System (5GS) and the Evolved Packet System (EPS), or between 5GS and other types of system, such as WiFi.

When the User Equipment (UE) is initially connected to 5GS, a node referred to as the PGW-C+SMF (control plane Packet Data Network (PDN) Gateway (PGW-C)+Session Management Function (SMF)) stores the PGW-C+SMF fully qualified domain name (FQDN) and network function (NF) instance identity for a connected Data Network Name (DNN)/Access Point Name (APN) into a Unified Data Management (UDM) node during a SMF registration procedure.

When the UE is initially connected to a WiFi network, the PGW-C+SMF also stores the PGW-C+SMF FQDN and NF instance identity for a connected DNN/APN into a UDM node during a SMF registration procedure, if the PGW-C+SMF uses a N10 interface for WiFi access.

During mobility from WiFi to 5GS or from 5GS to WiFi, the Access and Mobility Management Function (AMF) reads the SMF instance identity from UDM, or the evolved Packet Data Gateway (ePDG) downloads the PGW-C+SMF FQDN from an Authentication Authorisation and Accounting (AAA) server or Home Subscriber Server (HSS). It should be noted that the HSS queries this information from the UDM through the User Data Interworking, Coexistence and Migration (UDICOM) interface so that the serving nodes (AMF and ePDG) can select a proper PGW-C+SMF node to support PDU session continuity.

According to the 3GPP specification 3GPP TS 29.503 “5G System; Unified Data Management Services; Stage 3 (Release 17)”, v17.5.0 (2021-12), a NF service consumer (NFC), which could be, for example, an AMF or HSS, sends a request to the UDM to receive the UE's “Context In SMF” data. This data is referred to herein as “UEContextInSmfData”. The request contains the UE's identity/identifier (e.g. a subscription permanent identifier (SUPI), /{supi}), the type of the requested information (/ue-context-in-smf-data) and query parameters (supported-features). This request is illustrated in FIG. 1, which shows the signalling between a NFC and a NFP in the form of a UDM. Signal 1 is a GET request from the NFC to the UDM that includes the UE's identifier and the type of information requested (ue-context-in-smf-data).

On success, the UDM responds with “200 OK” (signal 2a) with the message body containing the UE's Context In SMF Data (UEContextInSmfData) relevant to the requesting NFC. If there is no valid subscription data for the UE identified in the request, a Hypertext Transfer Protocol (HTTP) status code “404 Not Found” is returned including additional error information in the response body (e.g. in the “ProblemDetails” element).

As shown in FIG. 2, the NF service consumer (e.g. AMF, HSS) can send a request to the UDM to subscribe to notifications of data changes of UeContextInSmfData. The request (signal 1 in FIG. 2) can contain a callback uniform resource indicator (URI) and the URI of the monitored resource.

On success (i.e. the creation of the subscription), the UDM responds with a “201 Created” message (signal 2a in FIG. 2). If there is no valid subscription data for the UE, a HTTP status code “404 Not Found” shall be returned (signal 2b in FIG. 2). If the UE subscription data exists, but the requested subscription to data change notifications cannot be created, a HTTP status code “501 Not Implemented” shall be returned (signal 2c in FIG. 2).

Once the subscription has been created in the UDM, the UDM notifies the NF service consumer (that has subscribed to receive such notifications) about subscription data change of UeContextInSmfData received in the SdmSubscription, as shown in FIG. 3. Thus, signal 1 in FIG. 3 shows the UDM sending the notification to the NFC, and signal 2 in FIG. 3 is a “204 No Content” message from the NFC to the UDM,

Section 6.1.6.2.16 of 3GPP TS 29.503 defines UEContextInSmfData as follows:

TABLE 6.1.6.2.16-1
Definition of type UeContextInSmfData

| Attribute name | Data type | P | Cardinality | Description |
|---|---|---|---|---|
| pduSessions | map(PduSession) | O | 0 . . . N | A map (list of key-value pairs where |
| | | | | pduSessionId converted from integer to string |
| | | | | serves as key; see clause 6.1.6.1) of |
| | | | | PduSessions. |
| pgwInfo | array(PgwInfo) | O | 1 . . . N | Information about the DNNs/APNs and PGW- |
| | | | | C + SMF FQDNs used in interworking with |
| | | | | EPS |
| emergencyInfo | EmergencyInfo | O | 0 . . . 1 | Information about emergency session |

Section 4.2.2.2.2 “General Registration” of 3GPP TS 23.502 “Procedures for the 5G System (5GS); Stage 2 (Release 17)” v17.3.0 (2021-12) describes that the AMF can get UeContextInSmfData and subscribe to UeContextInSmfData changes during a registration procedure.

In Section 4.3.2.2 “UE Requested PDU Session Establishment” of 3GPP TS 23.502, referring to 16c in 4.3.2.2.1, when a PDU session is established, the SMF registers with the UDM using Nudm_UECM_Registration (including SUPI, DNN, Single-Network Slice Selection Assistance Information (S-NSSAI), PDU Session ID, SMF Identity, Serving Public Land Mobile Network (PLMN) ID, [NID]) for a given PDU Session. As a result, the UDM stores the following information: SUPI, SMF identity and the associated DNN, S-NSSAI, PDU Session ID and Serving Network. The UDM may further store this information in the UDR by Nudr_DM_Update (including SUPI, Subscription Data, UE context in SMF data).

If the PDU session establishment is for an emergency service, then for an authenticated non-roaming UE, the SMF may register in the UDM using Nudm_UECM_Registration (including SUPI, PDU Session ID, SMF identity, Indication of Emergency Services) for a given PDU Session that is applicable for emergency services. As a result, the UDM shall store the applicable PDU Session for Emergency services.

If the AMF subscribed to UeContextInSmfData, the UDM will send a UeContextInSmfData notification to the AMF once the SMF/HSS registers the PDU session information or PGW information (pgw info) for a PDU session in UDM.

Similarly, a procedure for GET and Subscribe/Notify UeContextInSmfData from HSS towards UDM, and also a procedure for GET and Subscribe/Notify UeContextInPgwData from UDM towards HSS are defined in 3GPP TS 23.632 “User data interworking, coexistence and migration; Stage 2; (Release 17)”, v17.0.0 (2021-06), clause 5.3.4.

Section 6.2.6.2.2 of 3GPP TS 29.563 “5G System; Home Subscriber Server (HSS) services for interworking with Unified Data Management (UDM); Stage 3”, v17.3.0 (2021-12), defines UEContextInPgwData as shown in the table below:

TABLE 6.2.6.2.2-1
Definition of type UeContextInPgwData

| Attribute name | Data type | P | Cardinality | Description |
|---|---|---|---|---|
| pgwInfo | array (PgwInfo) | O | 1 . . . N | Information about the APNs and PGW-C + SMF |
| | | | | FQDNs used in interworking with UDM |

### SUMMARY

There currently exist certain challenge(s). Currently when an AMF or HSS retrieves or subscribes to UeContextInSmfData from a UDM, the whole UeContextInSmfData is retrieved or subscribed.

If a UE has multiple PDU sessions to be created, the UDM will notify UeContextInSmfData to AMF or HSS when each PDU session is established if the AMF or HSS has subscribed to UeContextInSmfData towards UDM. However, the AMF or HSS may only be interested in the Internet Protocol (IP) Multimedia Subsystem (IMS)-related or emergency PDU session that might be handed over between WiFi and 5GS. In this case, the notification of UeContextInSmfData of non-IMS-related PDU sessions, which are not useful for the AMF or HSS, increases unnecessary signalling in the network.

Thus, when the AMF or HSS retrieves UeContextInSmfData from UDM, UeContextInSmfData including all the PDU sessions will be transmitted from the UDM to the AMF or HSS. Similarly, the non-IMS related PDU sessions, which are unnecessary and useless for the AMF or HSS, increases the size of the data transmitted between the AMF or HSS and the UDM.

A similar problem occurs when a HSS retrieves or subscribes to UeContextInSmfData or UeContextInAmfData (EpsInterworkingInfo) from a UDM, or when a UDM retrieves or subscribes UeContextInPgwData from an HSS.

Certain aspects of the disclosure and their embodiments may provide solutions to these or other challenges.

In particular embodiments of this disclosure, new query parameters can be specified when a NF consumer (e.g. an AMF) uses the GET method to retrieve UeContextInSmfData to indicate that the AMF only needs to get the pduSessions and pgwInfo in UeContextInSmfData for the specified DNN, e.g. IMS DNN, or emergency service.

When a NF producer (e.g. a UDM) receives a GET request for UeContextInSmfData, the NFP will only send the pduSessions and pgwInfo for the specified DNN to the AMF (or other NFC), or it will only send the emergencyInfo to the AMF (or other NFC), according to the value of the query parameter(s).

Embodiments provide for a new parameter to be added to ‘SdmSubscription’ for the AMF (or other NFC) to indicate that the AMF is only subscribing to the changes of the pduSessions or pgwInfo in UeContextInSmfData for the specified DNN, e.g. IMS DNN, or emergencyInfo for emergency service. In some embodiments of this disclosure, this parameter is named “ueConSmfDataSubFilter”, and in other embodiments, this parameter is named “ueContextInSmfDataSubscription”.

Embodiments provide that the specified DNN can be configured in the AMF (or other NFC).

When changes of the pduSessions or pgwInfo of the specified DNN occur, the UDM (or other NFP) will only notify the AMF (or other NFC) of the corresponding pduSessions or pgwInfo in UeContextInSmfData. When changes of the emergency service session occur, the UDM (or other NFP) can only notify the AMF (or other NFC) of the emergencyInfo.

The above-mentioned solution refers to an AMF, a UDM and UeContextInSmfData as examples of a NF consumer, a NF producer and a target resource, respectively. It will be appreciated that the same principles described above can also be used in the following scenarios:
a HSS as NF consumer, a UDM as NF producer, and UeContextInSmfData or UeContextInAmfData (EpsInterworkingInfo) as target resources; and
a UDM as NF consumer, a HSS as NF producer, and UeContextInPGwData as target resource.

Thus, this disclosure provides a method for an AMF or HSS to only get and subscribe IMS-related pduSession or pgwInfo, or emergencyInfo. This will reduce the size of data transmissions and reduce notification signalling between an AMF or HSS (or other NFC) and a UDM (or other NFP).

Certain embodiments may provide one or more of the following technical advantage(s). With these embodiments, the PDU session(s) or PGW info data that the AMF/HSS are not-interested in will not be transmitted from the UDM to the AMF/HSS, which saves data transmission bandwidth between the AMF/HSS and the UDM.

As embodiments of this disclosure provide methods for AMF/HSS to only subscribe to a specified DNN or emergencyInfo changes of UeContextInSmfData, notification signalling to the AMF/HSS for non-interested PDU session(s) or PGW info changes can be avoided between the AMF/HSS and the UDM.

According to a first aspect, there is provided a method performed by an NFC. The method comprises sending a request to a NFP for context information for a first wireless device. The request comprises one or more filter values identifying a subset of context information for the first wireless device required by the NFC. The subset of context information for the first wireless device required by the NF consumer may be related to specific PDU sessions.

According to a second aspect, there is provided a method performed by an NFP. The method comprises receiving a request from an NFC for context information for a first wireless device. The request comprises one or more filter values identifying a subset of context information for the first wireless device required by the NFC; and sending wireless device context information to the NFC. The sent wireless device context information comprises a subset of context information for the first wireless device selected according to the one or more filter values. The subset of context information for the first wireless device required by the NF consumer may be related to specific PDU sessions. The context information may be stored by the NFP.

According to a third aspect, there is provided a network node configured to perform the method according to the first and/or second aspects, or any embodiments thereof.

According to a fourth aspect, there is provided a NFC configured to send a request to a NFP. The request is for context information for a first wireless device, and the request comprises one or more filter values identifying a subset of context information for the first wireless device required by the NFC. The subset of context information for the first wireless device required by the NF consumer may be related to specific PDU sessions.

According to a fifth aspect, there is provided a NFP configured to receive a request from a NF consumer. The request is for context information for a first wireless device, and the request comprises one or more filter values identifying a subset of context information for the first wireless device required by the NF consumer. The NFP is also configured to wireless device context information to the NF consumer. The sent wireless device context information comprises a subset of context information for the first wireless device selected according to the one or more filter values. The subset of context information for the first wireless device required by the NF consumer may be related to specific PDU sessions. The context information may be stored by the NFP.

According to a sixth aspect, there is provided a network node comprising a processor and a memory, said memory containing instructions executable by said processor whereby said network node is operative to perform the method according to the first and/or second aspects, or any embodiments thereof.

According to a seventh aspect, there is provided a NFC comprising a processor and a memory, said memory containing instructions executable by said processor whereby said NFC is operative to send a request to a NFP. The request is for context information for a first wireless device, and the request comprises one or more filter values identifying a subset of context information for the first wireless device required by the NFC. The subset of context information for the first wireless device required by the NF consumer may be related to specific PDU sessions.

According to an eighth aspect, there is provided a NFP comprising a processor and a memory, said memory containing instructions executable by said processor whereby said NFP is operative to receive a request from a NFC, where the request is for context information for a first wireless device, and the request comprises one or more filter values identifying a subset of context information for the first wireless device required by the NFC; and send wireless device context information to the NFC, where the sent wireless device context information comprises a subset of context information for the first wireless device selected according to the one or more filter values. The subset of context information for the first wireless device required by the NF consumer may be related to specific PDU sessions. The context information may be stored by the NFP.

According to a ninth aspect, there is provided a network node that comprises processing circuitry configured to cause the network node to perform any of the steps of the methods according to the first and/or second aspects, or any embodiments thereof; and power supply circuitry configured to supply power to the processing circuitry.

According to a tenth aspect, there is provided a computer program product comprising a computer readable medium having computer readable code embodied therein, the computer readable code being configured such that, on execution by a suitable computer or processor, the computer or processor is caused to perform the method according to the first and/or second aspects, or any embodiments thereof.

### BRIEF DESCRIPTION OF THE DRAWINGS

Some of the embodiments contemplated herein will now be described more fully with reference to the accompanying drawings, in which:

FIG. 1 is a diagram illustrating signalling involved in an NFC requesting UEContextInSmfData from an NFP in the form of a UDM;

FIG. 2 is a diagram illustrating signalling involved in an NFC subscribing to changes in UEContextInSmfData at an NFP in the form of a UDM;

FIG. 3 is a diagram illustrating signalling involved in an NFP in the form of a UDM notifying an NFC of changes in data that the NFC has subscribed for;

FIG. 4 is a diagram illustrating signalling between an NFC and an NFP according to some embodiments;

FIG. 5 is a diagram illustrating signalling between an NFC and a UDM according to some embodiments;

FIG. 6 is a diagram illustrating signalling between an NFC and a UDM according to some embodiments;

FIG. 7 is a flow chart illustrating a method performed by a NFC according to various embodiments;

FIG. 8 is a flow chart illustrating a method performed by a NFP according to various embodiments;

FIG. 9 shows an example of a communication system in accordance with some embodiments;

FIG. 10 shows a network node in accordance with some embodiments; and

FIG. 11 is a block diagram illustrating a virtualization environment in which functions implemented by some embodiments may be virtualized.

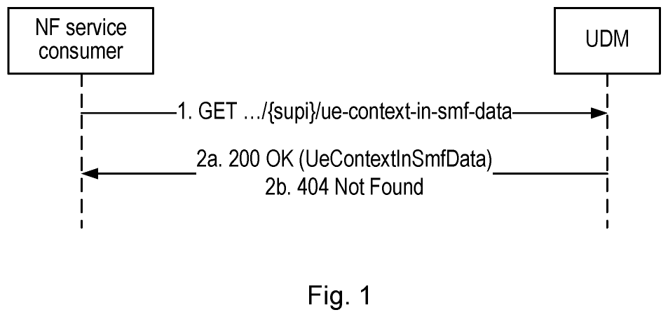

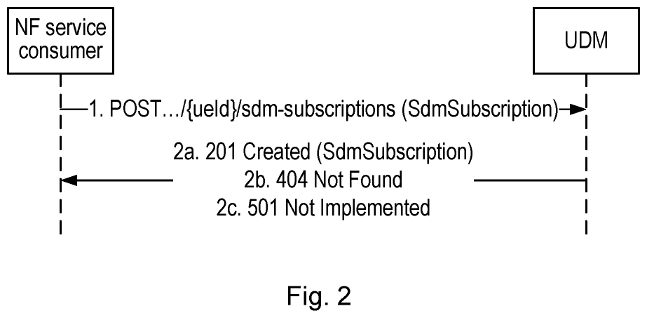

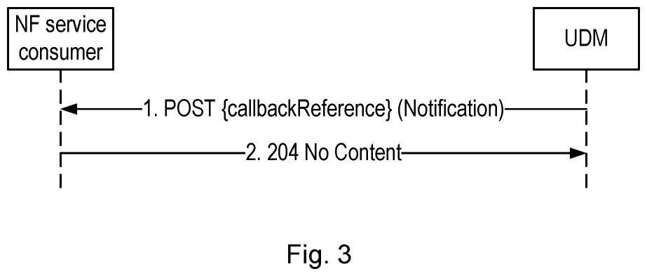

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the document provided in the Appendix.

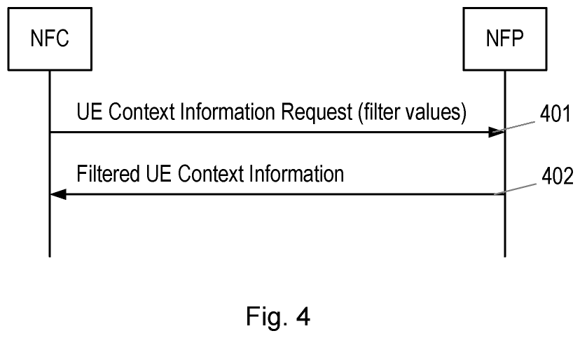

Briefly, embodiments of the techniques described herein relate to operations of a network node or NF that is acting as an NFC towards an NFP (i.e. the NFC requires a service performed by the NFP), and operations of a network node or NF that is acting as an NFP towards an NFC. FIG. 4 illustrates signalling between an NFC and NFP according to some embodiments. The NFC sends a request 401 to the NFP for context information for a UE or other wireless device. Signal 402 shows the NFP sending filtered UE context information to the NFC. The request 401 comprises one or more filter values that identify a subset of context information for the UE that the NFC is interested in receiving. That is, the NFC may not need or want to receive all context information for the UE that is stored by the NFP, and the filter value(s) in the request 401 enable the NFC to signal or indicate to the NFP which parts of the context information should be sent to the NFC in signal 402.

The request 401 may be a subscription request that establishes a subscription for the UE's context information at the NFP. In this way, the NFP will send the required context information when there is a change in the stored context information. Alternatively, the request 401 can be a retrieval request, in which case the NFP will send the required context information after receiving the request.

The filter values can indicate whether the NFC requires context information for IMS PDU sessions of emergency PDU sessions. The filter values can indicate whether the NFC wants to receive context information, for example, only for emergency services sessions, or for a specified network slice (e.g. a S-NSSAI), a specified network (e.g. DNN), and/or a specified mobile network (e.g. PLMN).

The context information requested by signal 401 can be any of UEContextInSmfData, UEContextInAmfData and UEContextInPgwData.

The NFC can be any of an AMF, a HSS and a UDM. The NFP can be any of a HSS and a UDM.

In particular embodiments, the NFC is an AMF and the NFP is a UDM. In these embodiments the context information can be UEContextInSmfData.

In particular embodiments, the NFC is a HSS and the NFP is a UDM. In these embodiments the context information can be UEContextInSmfData and/or UEContextInAmfData.

In particular embodiments, the NFP is a UDM and the NFP is an HSS. In these embodiments the context information can be UEContextInPgwData.

The following part of the description provides an exemplary implementation of the above solution for a NFC in the form of an AMF or HSS to request filtered UeContextInSmfData from a NFP in the form of a UDM. Those skilled in the art will appreciate from the description above and the exemplary implementation below how to adapt the implementation for situations where the NFC is a HSS, the NFP is a UDM and the target resource is UeContextInSmfData or UeContextInAmfData (EpsInterworkingInfo) as target resources. Likewise, a skilled person will appreciate how to adapt the implementation to situations where the NFC is a UDM, the NFP is a HSS and the target resource is UeContextInPGwData.

Thus, in the AMF/HSS→UDM scenario, one or more new parameter(s) (filter values) can be added. The parameters can be selected from: PLMN ID, singleNssai (sNssai), DNN and emergencyServices. These parameters can be added to query parameters in the GET method for UeContextInSmfData. This can be shown in the table below, which is a modified version of Table 6.1.3.7.1-1 “URI query parameters supported by the GET method on this resource” in 3GPP TS 29.503 (which is in section 6.1.3.7 Resource: UeContextInSmfData→6.1.3.7.3 Resources Standard Methods→6.1.3.7.3.1 GET). This example table shows all of the new parameters, but it will be appreciated that in particular implementations only one or a subset of these parameters may be included. The new information elements (IEs) in the table below are the “single-nssai”, “Dnn”, “emergencyServices” and “plmn-id”.

TABLE 6.1.3.7.1-1
URI query parameters supported by the GET method on this resource

| Name | Data type | P | Cardinality | Description |
|---|---|---|---|---|
| supported-features | SupportedFeatures | O | 0 . . . 1 | see 3GPP TS 29.500 [4] clause 6.6 |
| single-nssai | Snssai | O | 0 . . . 1 | When present without Slice Differentiator (sd), all |
| | | | | slices identified by the given Slice/Service Type |
| | | | | (sst) and any sd value (if any) shall be |
| | | | | considered matching the query parameter. |
| Dnn | Dnn | O | 0 . . . 1 | The dnn shall be the DNN Network Identifier |
| | | | | only. |
| | | | | If presents, it indicates UDM should only return |
| | | | | pduSession or pgwInfo of the dnn. |
| emergencyServices | boolean | O | 0 . . . 1 | Indication of Emergency Services; absence |
| | | | | indicates false. If presents, it indicates UDM |
| | | | | should only return emergencyInfo. |
| plmn-id | PlmnId | O | 0 . . . 1 | PLMN identity of the PLMN serving the UE |

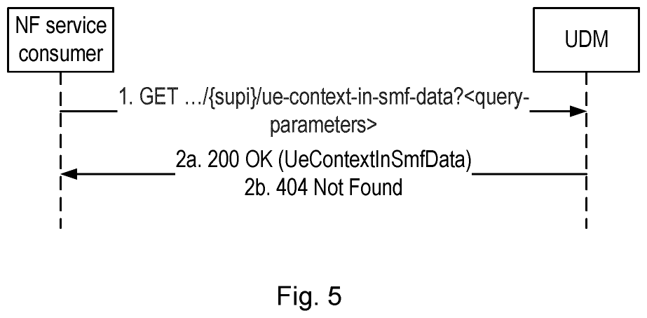

The corresponding procedure flow is shown in FIG. 5, which shows the NF service consumer (e.g. AMF, HSS) sending a GET request to the UDM to receive the UE's Context In SMF data. The request contains the UE's identity (/{supi}), the type of the requested information (/ue-context-in-smf-data) and (values for) new query parameters (supported-features, PLMN ID, singleNssai (sNssai), dnn and emergencyServices). In a particular alternative implementation, which is similar to the first SdmSubscription example below, the new parameters in Table 6.1.3.7.1-1 can instead be “dnnList” and “emergencyInd”,

These query parameters can also be added to a subscription request message. In particular, new parameters dnnList and emergencyInd are added to indicate the specific subscription information for UeContextInSmiData. This can be seen in the table below, which is a modified version of Table 6.1.6.2.3-1 “Definition of type SdmSubscription” in section 6.1.6.2.3 Type: SdmSubscription in 3GPP TS 29.503. The new IE in the table below is the ueConSmfDataSubFilter entry.

TABLE 6.1.6.2.3-1
Definition of type SdmSubscription

| Attribute | | | | |
|---|---|---|---|---|
| name | Data type | P | Cardinality | Description |
| nfInstanceId | NfInstanceId | M | 1 | Identity of the NF Instance creating the subscription. |
| implicitUnsubscribe | boolean | O | 0 . . . 1 | If present with value true indicates that the subscription |
| | | | | expires when the subscribing NF (AMF, SMF, SMSF) |
| | | | | identified by the nfInstanceld ceases to be registered |
| | | | | at the UDM. |
| | | | | When the subscribing NF is an SMF, this means that |
| | | | | the subscription is terminated by UDM when the last |
| | | | | PDU session of such SMF is deregistered for a given |
| | | | | SUPI. |
| | | | | If the subscribing NF (AMF. SMF, SMSF) is not |
| | | | | registered when the SDM subscription with |
| | | | | implicitUnsubscribe indicator set to true is received by |
| | | | | the UDM, the UDM should return a confirmed expiry |
| | | | | time in the expires attribute to the subscribing NF even |
| | | | | when the expires attribute is absent from the request. |
| | | | | See NOTE 1. |
| expires | DateTime | C | 0 . . . 1 | If present, indicates the point in time at which the |
| | | | | subscription expires. Shall be present if |
| | | | | implicitUnsubscribe is absent or false. |
| | | | | Within a POST request the proposed expiry time is |
| | | | | conveyed whereas in a POST response or PATCH |
| | | | | response the confirmed expiry time is returned. |
| callbackReference | Uri | M | 1 | URI provided by the NF service consumer to receive |
| | | | | notifications |
| amfServiceName | ServiceName | O | 0 . . . 1 | When present, this IE shall contain the name of the |
| | | | | AMF service to which Data Change Notifications are to |
| | | | | be sent (see clause 6.5.2.2 of 3GPP TS 29.500 [4]). |
| | | | | This IE may be included if the NF service consumer is |
| | | | | an AMF. |
| monitoredResourceUris | array (Uri) | M | 1 . . .N | A set of URIs that identify the resources for which a |
| | | | | change triggers a notification. |
| | | | | The URI shall take the form of either an absolute URI |
| | | | | or an absolute-path reference as defined in |
| | | | | IETF RFC 3986 [31]. |
| | | | | See NOTE 3. |
| singleNssai | Snssai | O | 0 . . . 1 | This IE may be present if the consumer is SMF. |
| | | | | This attribute shall be also used as filter for the Nudr |
| | | | | notifications when sdmSubscription is included in |
| | | | | subscriptionDataSubscription in Nudr POST operation. |
| | | | | See NOTE 2. |
| dnn | Dnn | O | 0 . . . 1 | This IE may be present if the consumer is SMF. |
| | | | | This attribute shall be also used as filter for the Nudr |
| | | | | notifications when sdmSubscription is included in |
| | | | | subscriptionDataSubscription in Nudr POST operation. |
| | | | | When present, this IE shall contain the Network |
| | | | | Identifier only, or Wildcard DNN. |
| | | | | See NOTE 2. |
| subscriptionId | string | C | 0 . . . 1 | This attribute shall be present if the SdmSubscription |
| | | | | is sent in a GET response message on Nudr. It |
| | | | | identifies the individual sdmSubscription stored in the |
| | | | | UDR and may be used by the UDM to delete an |
| | | | | expired or implicitly unsubscribed sdmSubscription. |
| plmnId | PlmnId | C | 0 . . . 1 | If present, it indicates the PLMN of the NF Instance |
| | | | | creating the subscription (i.e., the PLMN serving the |
| | | | | UE). |
| | | | | It shall be present if the NF Instance is located in a |
| | | | | different PLMN than the UDM. |
| | | | | If absent, the Home PLMN ID is used as default. |
| immediateReport | boolean | O | 0 . . . 1 | This IE indicates whether immediate report is needed |
| | | | | or not. |
| | | | | When present, this IE shall be set as following: |
| | | | | true: immediate report is required |
| | | | | false (default) immediate report is not required |
| report | ImmediateReport | C | 0 . . . 1 | This IE shall be present in Subscribe response, if the |
| | | | | immediateReport attribute is set to “true” in Subscribe |
| | | | | request. |
| | | | | When present, this IE shall contain the representation |
| | | | | of subscription data sets that to be monitored, i.e. |
| | | | | listed in monitoredResourceUris attribute. |
| supportedFeatures | SupportedFeatures | O | 0 . . . 1 | See clause 6.1.8 |
| | | | | These are the features supported by the NF |
| | | | | subscribing at the UDM. |
| contextInfo | ContextInfo | C | 0 . . . 1 | This IE if present may contain e.g. the headers |
| | | | | received by the UDM along with the SdmSubscription. |
| | | | | Shall be absent on Nudm and may be present on |
| | | | | Nudr. |
| nfChangeFilter | boolean | O | 0 . . . 1 | It may be present when monitoredResourceUris is |
| | | | | related to the ue-context-in-amf-data and ue-context- |
| | | | | in-smf-data. |
| | | | | If present, it indicates the consumer NF wants |
| | | | | notification when NF is changed in the ue-context-in- |
| | | | | amf-data and ue-context-in-smf-data. |
| ueConSmfDataSubFilter | UeContextInSmfDataSubFilter | O | 0 . . . 1 | This IE may be present to receive the notification on |
| | | | | changes for information in UeContextInSmfData |
| | | | | related to specific PDU sessions. |

| Attribute | |
|---|---|
| name | Applicability |
| nfInstanceId | |
| implicitUnsubscribe | |
| expires | |
| callbackReference | |
| amfServiceName | |
| monitoredResourceUris | |
| singleNssai | |
| dnn | |
| subscriptionId | |
| plmnId | |
| immediateReport | ImmediateReport |
| report | ImmediateReport |
| supportedFeatures | |
| contextInfo | |
| nfChangeFilter | ENA |
| ueConSmfDataSubFilter | UeConSmfDataSubFilter |

NOTE 1:
The subscription expires if the last registration identified by the nfInstanceId for the UE is deregistered at the UDM, e.g. the UDM shall remove the SdmSubscription of the SMF, if the UE's last PDU session SMF registration of this SMF is deregistered.
NOTE 2:
If “singleNssai” is not included, and “dnn” is not included, the UDM shall notify the data change of all DNN configurations and network slice(s).
If “singleNssai” is included, and “dnn” is not included, the UDM shall notify the data change of network slice identified by “singleNssai” and all DNN configurations for the requested network slice identified by “singleNssai”.
If “singleNssai” is not included, and “dnn” is included, the UDM shall notify the data change of all network slices where such DNN is available and all DNN configurations identified by “dnn”.
If “singleNssai” is included, and “dnn” is included, the UDM shall notify the data change of network slice identified by “singleNssai” where such DNN is available and the DNN configuration identified by “dnn”, if such DNN is available in the network slice identified by “singleNssai”.
NOTE 3:
The UDM should handle only the relative-path part (apiSpecificResourceUriPart, see 3GPP TS 29.501 [5] clause 4.4.1) and ignore possible inconsistencies in the base URI part.

A new subsection defining ueConSmfDataSubFilter is required, and this can be in section 6.1.6.2.x of 3GPP TS 29.503, as shown by the exemplary table below.

TABLE 6.1.6.2.xx-1
Definition of type UeConSmfDataSubFilter

| Attribute name | Data type | P | Cardinality | Description |
|---|---|---|---|---|
| dnnList | array(Dnn) | C | 1 . . . N | This IE shall be present to get the pduSesion and pgwInfo |
| | | | | in UeContextInSmfData for specific DNN(s). |
| | | | | When present, the UDM shall notify the changes of |
| | | | | pduSesion and pgwInfo in UeContextInSmfData for the |
| | | | | indicated DNN(s). |
| | | | | When this IE is not present, the UDM will not notify |
| | | | | changes of pduSesion and pgwInfo. |
| emergencyInd | boolean | C | 0 . . . 1 | This IE shall be present and set to value “true” for |
| | | | | changes on the emergencyInfo in UeContextInSmfData. |
| | | | | When present, this IE shall indicate whether the UDM |
| | | | | shall notify the changes on emergencyInfo in |
| | | | | UeContextInSmfData: |
| | | | | true: changes on emergencyInfo to be notified |
| | | | | false (default) changes on emergencyInfo not to be |
| | | | | notified. |

The optional features in Table 6.1.8-1 below are defined for the Nudm_SDM Application Programming Interface (API). They can be negotiated using the extensibility mechanism defined in clause 6.6 of 3GPP TS 29.500.

TABLE 6.1.8-1
Supported Features

| Feature | | |
|---|---|---|
| number | Feature Name | Description |
| 1 | SharedData | When receiving a Nudm_SDM_Get service operation request to retrieve |
| | | a UE's individual subscription data, and the request does not contain a |
| | | supported-features query parameter indicating support of this feature, the |
| | | UDM shall not include Shared Data Ids in the response. Instead the UDM |
| | | may - based on operator policy - take no further action (i.e. allow the UE |
| | | to get services based on only the UE's individual subscription data), or |
| | | send the shared data as individual data (this may result in notifications of |
| | | individual subscription data change - if so subscribed - when shared |
| | | data, which are sent as individual data, are modified, and/or when the |
| | | UE's Shared Data IDs are modified). |
| 2 | ImmediateReport | When a NF consumer detects the UDM support ImmediateReport |
| | | feature, it can indicate an immediateReport flag when invoking |
| | | Nudm_SDM_Subscribe service operation. If UDM supports |
| | | ImmediateReport received Nudm_SDM_Subscribe service operation |
| | | request, it shall return the resource representation(s) of the monitored |
| | | resource(s) in the service operation response body. |
| 3 | PatchReport | If some of the modifications included in the PATCH request are not |
| | | successfully implemented, the UDM reports the result of PATCH request |
| | | execution to the consumer. See clause 5.2.7.2 of 3GPP TS 29.500 [4]. |
| 4 | Nssaa | If the NF consumer does not support this feature, the UDM shall not |
| | | include information of S-NSSAI(s) subject to Network Slice-Specific |
| | | Authentication and Authorization in the message body with “200 OK” |
| | | response (See clause 5.2.2.2.2). |
| 5 | CAGFeature | If the NF consumer does not support this feature, the UDM shall not |
| | | include CAG information list in the message body with “200 OK” |
| | | response (clause 5.2.2.2.3). The UDM performs action as executes step |
| | | 2c of clause 5.3.2.2.2 and 5.3.2.2.3 if UE is allowed to access 5GS via |
| | | CAG cell(s) only. |
| 6 | SharedDataTreatment | This feature is an extension to the SharedData feature, i.e. support of |
| | | SharedDataTreatment requires support of SharedData. |
| | | When receiving a Nudm_SDM_Get service operation request to retrieve |
| | | a UE's individual subscription data, and the request does not contain a |
| | | supported-features query parameter indicating support of this feature, the |
| | | UDM shall not include SharedDataTreatments in the SharedData |
| | | returned in the response. Instead the UDM may - based on operator |
| | | policy - take no further action (i.e. allow the UE to get services based on |
| | | default treatment (i.e. individual data take precedence), or send the |
| | | shared data which have non-default treatment as individual data. |
| 7 | sorTransparentSupport | This flag indicates NF Consumer (e.g. AMF) support of receiving SoR |
| | | Transparent Container instead of individual IEs from NF Producer (e.g. |
| | | UDM). If the NF consumer does not support this feature, the NF |
| | | Producer shall not include sorTransparentContainer, as defined in clause |
| | | 6.1.6.2.26. |
| | | Corresponding flag is also used by UDM to register (in NRF) its support |
| | | of receiving SoR Transparent Container instead of individual IEs from the |
| | | NF Consumer (e.g. AMF). If the UDM does not support this feature, the |
| | | NF Consumer shall not include sorTransparentContainer, as defined in |
| | | clause 6.1.6.2.25. |
| 8 | Nsac | If the NF consumer does not support this feature, the UDM shall not |
| | | include network slice admission control related information for S- |
| | | NSSAI(s) in the message body with “200 OK” response (See |
| | | clause 5.2.2.2.3). |
| 9 | SharedSmSubsData | If the NF consumer does not support this feature, the UDM shall not take |
| | | the alternative to include extendedSmSubsData in SmSubsData |
| | | (clause 6.1.6.2.79). |
| 10 | ENA | Enhanced Network Automation. |
| | | If the UDM supports this feature, the UDM shall handle the the |
| | | nfChangeFilter IE received in the sdmSubscription and sends the |
| | | notifications accordingly (See clause 6.1.6.2.16 and 6.1.6.2.70). |
| | | If the NF consumer does not support this feature, the UDM shall send the |
| | | change notification on the full resource. |
| 11 | Nssrg | The NF consumer (i.e. AMF) that supports this feature shall support |
| | | handling of NSSRG information received along with the subscribed S- |
| | | NSSAIs as defined in clause 5.15.12 of 3GPP TS 23.501 [2]. |
| | | If the NF consumer does not support this feature, the UDM may select |
| | | the subset of the compatible Subscribed S-NSSAIs without including any |
| | | information of Network Slice Simultaneous Registration Group. |
| 12 | upuTransparentSupport | This flag indicates NF Consumer (e.g. AMF) support of receiving UE |
| | | Parameters Update Transparent Container instead of individual IEs from |
| | | NF Producer (e.g. UDM). If the NF consumer does not support this |
| | | feature, the NF Producer shall not include upuTransparentContainer, as |
| | | defined in clause 6.1.6.2.33. |
| | | Corresponding flag is also used by UDM to register (in NRF) its support |
| | | of receiving UE Parameters Update Transparent Container instead of |
| | | individual IEs from the NF Consumer (e.g. AMF). If the UDM does not |
| | | support this feature, the NF Consumer shall not include |
| | | upuTransparentContainer, as defined in clause 6.1.6.2.25. |
| xx | UeConSmfDataSubFilter | UE Context in Smf Data Subscription Filter |
| | | If the UDM supports this feature, the UDM shall handle the the |
| | | ueConSmfDataSubFilter IE received in the sdmSubscription and sends |
| | | the notifications only for changes indicated in the IE. |

The following presents an alternative embodiment for query parameters to be added to the subscription request message. In particular, new parameters PLMN ID, singleNssai (sNssai), dnn and emergencyServices are added to sdmSubscription to indicate the specific subscription information for UeContextinSmfData. This can be seen in the table below, which is a modified version of Table 6.1.6.2.3-1 “Definition of type SdmSubscription” in section 6.1.6.2.3 Type: SdmSubscription in 3GPP TS 29.503. The new IE in the table below is the ueContextInSmfDataSubscription entry.

TABLE 6.1.6.2.3-1
Alternative definition of type SdmSubscription

| Attribute | | | | |
|---|---|---|---|---|
| name | Data type | P | Cardinality | Description |
| nfInstanceId | NfInstanceId | M | 1 | Identity of the NF Instance creating the |
| | | | | subscription. |
| implicitUnsubscribe | boolean | O | 0 . . . 1 | If present with value true indicates that the |
| | | | | subscription expires when the subscribing NF |
| | | | | (AMF, SMF, SMSF) identified by the |
| | | | | nfInstanceId ceases to be registered at the |
| | | | | UDM. |
| | | | | When the subscribing NF is an SMF, this |
| | | | | means that the subscription is terminated by |
| | | | | UDM when the last PDU session of such SMF |
| | | | | is deregistered for a given SUPI. |
| | | | | If the subscribing NF (AMF. SMF, SMSF) is |
| | | | | not registered when the SDM subscription |
| | | | | with implicitUnsubscribe indicator set to true is |
| | | | | received by the UDM, the UDM should return |
| | | | | a confirmed expiry time in the expires attribute |
| | | | | to the subscribing NF even when the expires |
| | | | | attribute is absent from the request. |
| | | | | See NOTE 1. |
| expires | DateTime | C | 0 . . . 1 | If present, indicates the point in time at which |
| | | | | the subscription expires. Shall be present if |
| | | | | implicitUnsubscribe is absent or false. |
| | | | | Within a POST request the proposed expiry |
| | | | | time is conveyed whereas in a POST |
| | | | | response or PATCH response the confirmed |
| | | | | expiry time is returned. |
| callbackReference | Uri | M | 1 | URI provided by the NF service consumer to |
| | | | | receive notifications |
| amfServiceName | ServiceName | O | 0 . . . 1 | When present, this IE shall contain the name |
| | | | | of the AMF service to which Data Change |
| | | | | Notifications are to be sent (see clause |
| | | | | 6.5.2.2 of 3GPP TS 29.500 [4]). This IE may |
| | | | | be included if the NF service consumer is an |
| | | | | AMF. |
| monitoredResourceUris | array(Uri) | M | 1 . . . N | A set of URIs that identify the resources for |
| | | | | which a change triggers a notification. |
| | | | | The URI shall take the form of either an |
| | | | | absolute URI or an absolute-path reference |
| | | | | as defined in IETF RFC 3986 [31]. |
| singleNssai | Snssai | O | 0 . . . 1 | This IE may be present if the consumer is |
| | | | | SMF. |
| | | | | This attribute shall be also used as filter as |
| | | | | filter for the Nudr notifications when |
| | | | | sdmSubscription is included in |
| | | | | subscriptionDataSubscription in Nudr POST |
| | | | | operation. |
| | | | | See NOTE 2. |
| dnn | Dnn | O | 0 . . . 1 | This IE may be present if the consumer is |
| | | | | SMF. |
| | | | | This attribute shall be also used as filter for |
| | | | | the Nudr notifications when sdmSubscription |
| | | | | is included in subscriptionDataSubscription in |
| | | | | Nudr POST operation. |
| | | | | When present, this IE shall contain the |
| | | | | Network Identifier only. |
| | | | | See NOTE 2. |
| subscriptionId | string | C | 0 . . . 1 | This attribute shall be present if the |
| | | | | SdmSubscription is sent in a GET response |
| | | | | message on Nudr. It identifies the individual |
| | | | | sdmSubscription stored in the UDR and may |
| | | | | be used by the UDM to delete an expired or |
| | | | | implicitly unsubscribed sdmSubscription. |
| plmnId | PlmnId | C | 0 . . . 1 | If present, it indicates the PLMN of the NF |
| | | | | Instance creating the subscription (i.e., the |
| | | | | PLMN serving the UE). |
| | | | | It shall be present if the NF Instance is |
| | | | | located in a different PLMN than the UDM. |
| | | | | If absent, the Home PLMN ID is used as |
| | | | | default. |
| immediateReport | boolean | O | 0 . . . 1 | This IE indicates whether immediate report is |
| | | | | needed or not. |
| | | | | When present, this IE shall be set as |
| | | | | following: |
| | | | | true: immediate report is required |
| | | | | false (default) immediate report is not |
| | | | | required |
| report | SubscriptionDataSets | C | 0 . . . 1 | This IE shall be present in Subscribe |
| | | | | response, if the immediateReport attribute is |
| | | | | set to “true” in Subscribe request. |
| | | | | When present, this IE shall contain the |
| | | | | representation of subscription data sets that |
| | | | | to be monitored, i.e. listed in |
| | | | | monitoredResourceUris attribute. |
| supportedFeatures | SupportedFeatures | O | 0 . . . 1 | See clause 6.1.8 |
| | | | | These are the features supported by the NF |
| | | | | subscribing at the UDM. |
| contextInfo | ContextInfo | C | 0 . . . 1 | This IE if present may contain e.g. the |
| | | | | headers received by the UDM along with the |
| | | | | SdmSubscription. |
| | | | | Shall be absent on Nudm and may be present |
| | | | | on Nudr. |
| ueContextInSmfDataSubscription | UeContextInSmfDataSubscription | O | 0 . . . 1 | When present, this attribute indicates the |
| | | | | specific subscription condition of |
| | | | | UeContextInSmfData. |
| | | | | When not present, if UeContextInSmfData is |
| | | | | subscribed, the whole UeContextInSmfData is |
| | | | | subscribed. |

| Attribute | |
|---|---|
| name | Applicability |
| nfInstanceId | |
| implicitUnsubscribe | |
| expires | |
| callbackReference | |
| amfServiceName | |
| monitoredResourceUris | |
| singleNssai | |
| dnn | |
| subscriptionId | |
| plmnId | |
| immediateReport | ImmediateReport |
| report | ImmediateReport |
| supportedFeatures | |
| contextInfo | |
| ueContextInSmfDataSubscription | |

A new subsection defining ueContextInSmfDataSubscription is required, and this can be in section 6.1.6.2.x of 3GPP TS 29.503, as shown by the exemplary table below.

TABLE 6.1.6.2.x-1
Definition of type UeContextInSmfDataSubscription

| Attribute name | Data type | P | Cardinality | Description |
|---|---|---|---|---|
| single-nssai | Snssai | O | 0 . . . 1 | When present without Slice Differentiator (sd), |
| | | | | all slices identified by the given Slice/Service |
| | | | | Type (sst) and any sd value (if any) shall be |
| | | | | considered matching the query parameter. |
| dnn | Dnn | O | 0 . . . 1 | This IE may be present if the consumer is |
| | | | | AMF/HSS. |
| | | | | This attribute shall be used as filter for the Nudr |
| | | | | notifications when the subscription is for ‘ue- |
| | | | | context-in-smf-data’. |
| | | | | When present, UDM shall only send |
| | | | | UeContextInSmfData contains pduSessions or |
| | | | | pgwInfo for the dnn when notify the change of |
| | | | | UeContextInSmfData to the consumer. |
| emergencyServices | boolean | O | 0 . . . 1 | Indication of Emergency Services; absence |
| | | | | indicates false. |
| | | | | This attribute shall be used as filter for the Nudr |
| | | | | notifications when the subscription is for “ue- |
| | | | | context-in-smf-data”. |
| | | | | When present, UDM shall only send |
| | | | | UeContextInSmfData contains emergencyInfo |
| | | | | when notify the change UeContextInSmfData to |
| | | | | the consumer. |
| plmn-id | PlmnId | O | 0 . . . 1 | PLMN identity of the PLMN serving the UE |

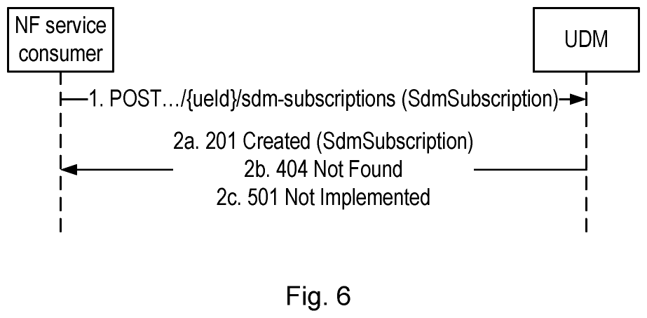

The corresponding procedure flow for the subscription embodiments is shown in FIG. 6. The NF service consumer (e.g. AMF, HSS) sends a subscription request to the UDM to subscribe to notifications of data change of UeContextInSmfData. The request contains a callback URI and the URI of the monitored resource, also the new subscription configuration data (the filter values).

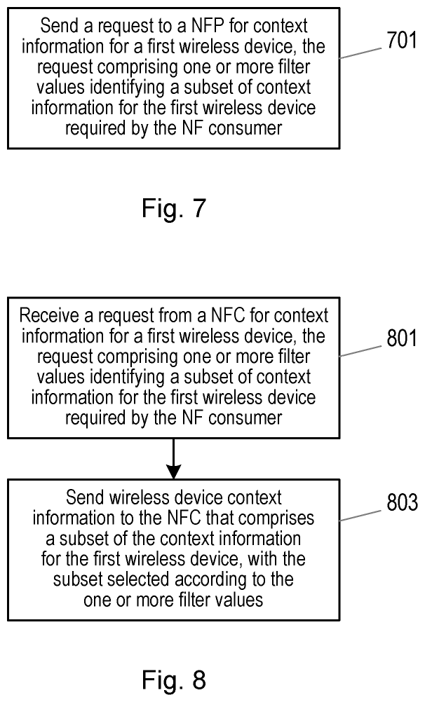

FIG. 7 is a flow chart illustrating a method performed by a NFC according to various embodiments. The method can be performed by a network node in the communication network. The network node/NFC may be an AMF, a HSS, or a UDM node. The NFC/network node may perform the method in response to executing suitably formulated computer readable code. The computer readable code may be embodied or stored on a computer readable medium, such as a memory chip, optical disc, or other storage medium. The computer readable medium may be part of a computer program product.

In step 701, the NFC sends a request (e.g. request 401) to a NFP. The request is for context information for a first wireless device (e.g. a first UE), and the request comprises one or more filter values identifying a subset of context information for the first wireless device required by the NFC. The NFP may be a HSS or a UDM node.

The request may be a subscription request for context information for the first wireless device, such that the NFP sends context information to the NFC when the context information changes. Alternatively, the request may be a retrieval request for context information for the first wireless device, such that the NFP sends context information to the NFC in response to the retrieval request.

The context information that the subscription request relates to can be any of: UEContextInSmfData, UEContextInAmfData and UEContextInPgwData.

The subset of context information for the first wireless device required by the NF consumer can be related to specific PDU sessions. For example, in some embodiments, the one or more filter values comprised in the request can indicate whether the NFC requires context information for IMS PDU sessions or emergency PDU sessions.

In some embodiments, the filter values comprised in the request can relate to any one or more of: a network slice to which the subset of context information is to relate; S-NSSAI to which the subset of context information is to relate; an identifier of a data network to which the subset of context information is to relate; a DNN identifier to which the subset of context information is to relate; a list of data networks to which the subset of context information is to relate; a list of DNNs to which the subset of context information is to relate; a network identifier for the network serving the first wireless device; a PLMN identifier of the PLMN serving the first wireless device; and the presence or absence of emergency services information.

In some embodiments, the NFC receives wireless device context information from the NFP (e.g. as shown by signal 402 in FIG. 4). The received wireless device context information can comprise the subset of context information for the first wireless device according to the one or more filter values.

FIG. 8 is a flow chart illustrating a method performed by a NFP according to various embodiments. The method can be performed by a network node in the communication network. The NFP/network node may be a HSS or a UDM node. The NFP/network node may perform the method in response to executing suitably formulated computer readable code. The computer readable code may be embodied or stored on a computer readable medium, such as a memory chip, optical disc, or other storage medium. The computer readable medium may be part of a computer program product.

In step 801, the NFP receives a request (e.g. request 401) from a NFC. The request is for context information for a first wireless device (e.g. a first UE), and the request comprises one or more filter values identifying a subset of context information for the first wireless device required by the NFC.

In step 803, wireless device context information is sent to the NFC (e.g. as shown by signal 402 in FIG. 4). The wireless device context information comprises a subset of context information for the first wireless device selected according to the one or more filter values. This wireless device context information can be context information stored by the NFP.

The context information that the subscription request relates to can be any one of: UEContextInSmfData, UEContextInAmfData and UEContextInPgwData.

The received request may be a subscription request for context information for the first wireless device, and the NFP can send the wireless device context information to the NFC when there is a change to the context information stored by the NFP for the first wireless device. Alternatively, the received request may be a retrieval request for context information for the first wireless device, such that the NFP sends the wireless device context information to the NFC in response to receiving the retrieval request.

The subset of context information for the first wireless device required by the NF consumer can be related to specific PDU sessions. For example, in some embodiments, the one or more filter values comprised in the request can indicate whether the NFC requires context information for IMS PDU sessions or emergency PDU sessions.

In some embodiments, the filter values comprised in the request can relate to any one or more of: a network slice to which the subset of context information is to relate; S-NSSAI to which the subset of context information is to relate; an identifier of a data network to which the subset of context information is to relate; a DNN identifier to which the subset of context information is to relate; a list of data networks to which the subset of context information is to relate; a list of DNNs to which the subset of context information is to relate; a network identifier for the network serving the first wireless device; a PLMN identifier of the PLMN serving the first wireless device; and the presence or absence of emergency services information.

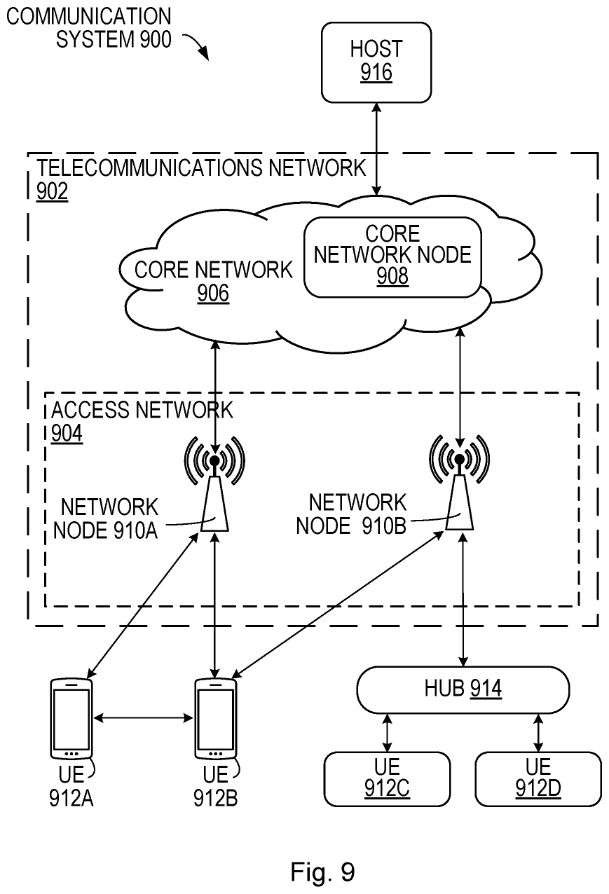

FIG. 9 shows an example of a communication system 900 in which some embodiments can be implemented.

In the example, the communication system 900 includes a telecommunication network 902 that includes an access network 904, such as a radio access network (RAN), and a core network 906, which includes one or more core network nodes 908. The access network 904 includes one or more access network nodes, such as access network nodes 910a and 910b (one or more of which may be generally referred to as access network nodes 910), or any other similar 3^{rd} Generation Partnership Project (3GPP) access node or non-3GPP access point. The access network nodes 910 facilitate direct or indirect connection of wireless devices (also referred to interchangeably herein as user equipment (UE)), such as by connecting UEs 912a, 912b, 912c, and 912d (one or more of which may be generally referred to as UEs 912) to the core network 906 over one or more wireless connections. The access network nodes 910 may be, for example, access points (APs) (e.g. radio access points), base stations (BSs) (e.g. radio base stations, Node Bs, evolved Node Bs (eNBs) and NR NodeBs (gNBs)).

Unless otherwise indicated, the term ‘network node’ is used herein to refer to both access network nodes 910 and core network nodes 908

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The wireless devices/UEs 912 may be any of a wide variety of communication devices, including wireless devices arranged, configured, and/or operable to communicate wirelessly with the network nodes 910 and other communication devices. Similarly, the access network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the access network nodes 910 to one or more hosts, such as host 916. These connections may be direct or indirect via one or more intermediary networks or devices. In other examples, network nodes may be directly coupled to hosts. The core network 906 includes one more core network nodes (e.g. core network node 908) that are structured with hardware and software components. Features of these components may be substantially similar to those described with respect to the wireless devices/UEs, access network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the wireless devices/UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 9, the hub 914 communicates with the access network 904 to facilitate indirect communication between one or more UEs (e.g. UE 912c and/or 912d) and access network nodes (e.g. access network node 910b). In some examples, the hub 914 may be a controller, router, a content source and analytics node, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g. UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

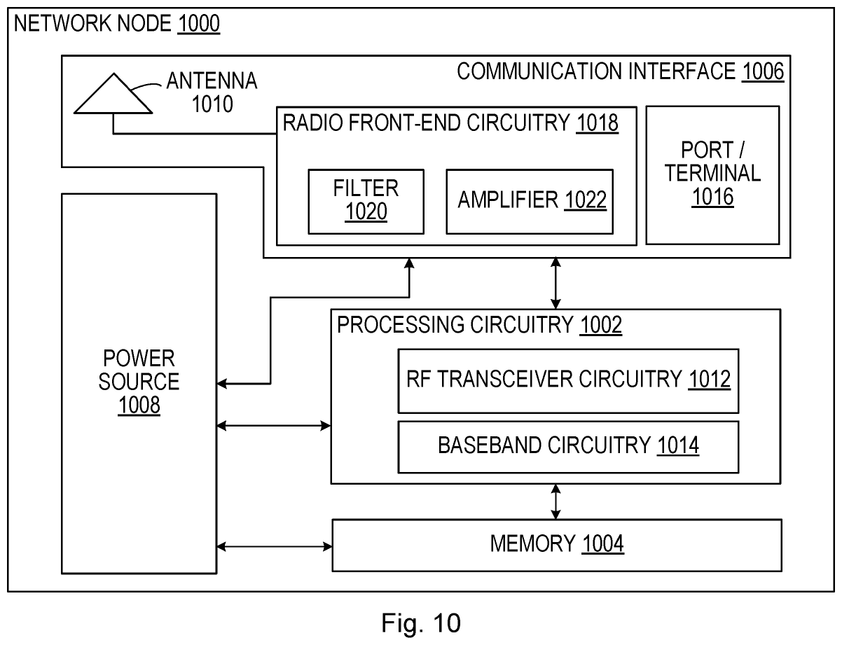

FIG. 10 shows a network node 1000 in accordance with some embodiments. As used herein, network node refers generally to equipment capable, configured, arranged and/or operable to communicate directly or indirectly with a UE and/or with other network nodes or equipment, in a telecommunication network. Examples of network nodes include, but are not limited to, access network nodes such as access points (APs) (e.g. radio access points), base stations (BSs) (e.g. radio base stations, Node Bs, evolved Node Bs (eNBs) and NR NodeBs (gNBs)). Other examples of network nodes include, but are not limited to, core network nodes (e.g. core network node 908 in core network 906) such as nodes that include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. An access network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of access network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The network node 1000 includes processing circuitry 1002, a memory 1004, a communication interface 1006, and a power source 1008, and/or any other component, or any combination thereof. The network node 1000 may be composed of multiple physically separate components (e.g. a NodeB component and a RNC component, or a BTS component and a BSC component, etc.), which may each have their own respective components. In certain scenarios in which the network node 1000 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g. separate memory 1004 for different RATs) and some components may be reused (e.g. a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality. For example, the processing circuitry 1002 may be configured to cause the network node to perform the methods as described above and/or as defined in the embodiment statements below.

In some embodiments, the processing circuitry 1002 includes a system on a chip (SOC). In some embodiments, for example where the network node 1000 is an access network node, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units. In embodiments where the network node 1000 is in the form of a core network node, the RF transceiver circuitry 1012 and baseband processing circuitry 1014 are not present in the network node 1000.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signalling and/or data between network nodes, the access network, the core network, and/or a UE. As illustrated, the communication interface 1006 comprises port(s)/terminal(s) 1016 to send and receive data, for example to and from a network over a wired connection.

In embodiments where the network node 1000 is an access network node, the communication interface 1006 also includes radio front-end circuitry 1018 that may be coupled to, or in certain embodiments a part of, the antenna 1010. In embodiments where the network node 1000 is a core network node, the core network node may not include radio front-end circuitry 1018 and antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the access network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g. at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g. the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

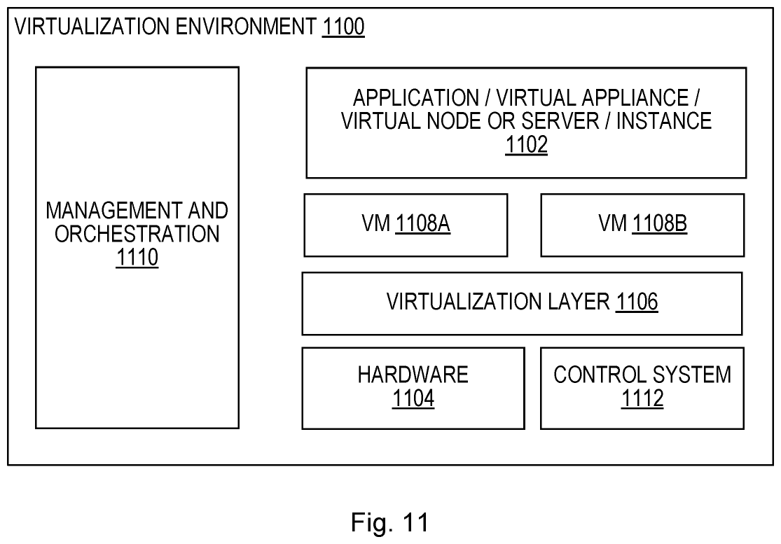

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as one or more core network nodes. In some embodiments, the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 1112 which may alternatively be used for communication between hardware nodes and radio units.

Although the computing devices described herein (e.g. network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1-52. (canceled)

53. A method performed by a first network function (NF), the method comprising:
sending to a second NF a request for context information in a third NF for a first wireless device, wherein the request further comprises one or more filter values identifying the requested context information, wherein the context information is related to at least one specific Protocol Data Unit (PDU) session; and
receiving wireless device context information from the second NF, wherein the received wireless device context information comprises the context information for the first wireless device according to the at least one filter value.

54. The method of claim 53, wherein the request is a subscription request to receive notification on changes for context information for the first wireless device, such that the second NF sends context information to the first NF when the context information changes; or the request is a retrieval request for context information for the first wireless device, such that the second NF sends context information to the first NF in response to the retrieval request.

55. The method of claim 53, wherein the context information is any one of: UEContextInSmfData, UEContextInAmfData and UEContextInPgwData; wherein the one or more filter values indicate whether the first NF requires context information for Internet Protocol Multimedia Subsystem, IMS, PDU sessions or emergency PDU sessions.

56. The method of claim 53, wherein the filter values relate to:
a list of Single-Network Slice Selection Assistance Information, S-NSSAI to which the subset of context information is to relate;
a list of DNNs to which the subset of context information is to relate; or
indication of the presence or absence of emergency services information.

57. The method of claim 53, wherein the first NF is one of: an Access and Mobility Management Function, AMF, a Home Subscriber Server, HSS, and a Unified Data Management, UDM, node; wherein the second NF is one of: a Home Subscriber Server, HSS, and a Unified Data Management, UDM, node.

58. A method performed by a second network function (NF), the method comprising:
receiving, from a first NF, a request for context information for a first wireless device, wherein the request comprises one or more filter values identifying the requested context information, and the context information is related to at least one specific Protocol Data Unit (PDU) session; and
sending wireless device context information to the first NF, wherein the sent wireless device context information comprises context information for the first wireless device according to the one or more filter values.

59. The method of claim 58, wherein the received request is a subscription request to receive notification on changes for context information for the first wireless device, such that the second NF sends the wireless device context information to the first NF when there is a change to the context information stored by the second NF for the first wireless device; or the received request is a retrieval request for context information for the first wireless device, such that the second NF sends the wireless device context information to the first NF in response to receiving the retrieval request.

60. The method of claim 58, wherein the context information is any one of: UEContextInSmfData, UEContextInAmfData and UEContextInPgwData; wherein the one or more filter values indicate whether the first NF requires context information for Internet Protocol Multimedia Subsystem, IMS, PDU sessions or emergency PDU sessions.

61. The method of claim 58, wherein the filter values relate to:
a list of Single-Network Slice Selection Assistance Information, S-NSSAI to which the subset of context information is to relate;
a list of Data Network Name, DNN to which the context information is to relate; or
indication of the presence or absence of emergency services information.

62. The method of claim 58, wherein the first NF is one of: an Access and Mobility Management Function, AMF, a Home Subscriber Server, HSS, and a Unified Data Management, UDM, node; wherein the second NF is one of: a Home Subscriber Server, HSS, and a Unified Data Management, UDM, node.

63. A first Network Function (NF) node, comprising:
processing circuitry;
a memory containing instructions executable by the processing circuitry;
a transmitter for transmitting to a second NF a request for context information in a third NF for a first wireless device, wherein the request further comprises one or more filter values identifying the requested context information, wherein the context information is related to at least one specific Protocol Data Unit (PDU) session; and
a receiver for receiving wireless device context information from the second NF, wherein the received wireless device context information comprises the context information for the first wireless device according to the at least one filter value.

64. The first NF node of claim 63, wherein the request is a subscription request to receive notification on changes for context information for the first wireless device, such that the second NF sends context information to the first NF when the context information changes; or the request is a retrieval request for context information for the first wireless device, such that the second NF sends context information to the first NF in response to the retrieval request.

65. A second Network Function (NF) node, comprising:
processing circuitry;
a memory containing instructions executable by the processing circuitry;
a receiver for receiving from a first NF, a request for context information for a first wireless device, and wherein the request further comprises one or more filter values identifying the requested context information, wherein the context information is related to at least one specific Protocol Data Unit (PDU) session; and
a transmitter for transmitting wireless device context information to the first NF, wherein the sent wireless device context information comprises context information for the first wireless device according to the one or more filter values.

66. The second NF node of claim 13, wherein the received request is a subscription request to receive notification on changes for context information for the first wireless device, such that the second NF sends the wireless device context information to the first NF when there is a change to the context information stored by the second NF for the first wireless device; or the received request is a retrieval request for context information for the first wireless device, such that the second NF sends the wireless device context information to the first NF in response to receiving the retrieval request.
